(19) United States
(12) Patent Application Publication
(10) Pub. No.: US 2022/0355357 A1
(43) Pub. Date: Nov. 10, 2022

(54) Force Measuring Device for Measuring Drawing Forces During Wire Drawing

(71) Applicant: FMS Force Measuring Systems AG, Obrerglatt (CH)

(72) Inventor: Jörg INHELDER, Nürensdorf (CH)

(21) Appl. No.: 17/772,626

(22) PCT Filed: Oct. 28, 2020
(86) PCT No.: PCT/EP2020/080259

§ 371 Date: Apr. 28, 2022

(30) Foreign Application Priority Data
Oct. 31, 2019 (EP) 19206446.7

(51) Int. Cl. B21C 1/12; B21C 3/14; B21C 51/00

(52) U.S. Cl. CPC B21C 1/12; B21C 3/14; B21C 51/00

(57) ABSTRACT

The present invention relates to a force measuring device (10) for measuring drawing forces on a drawing stock (30) in three dimensions, having
a force application element (12) and, arranged spaced apart therefrom, a support element (14), each of which comprises a passage opening for the drawing stock (30),
one or more connecting elements (16) that are deformable in three dimensions and that connect the force application element (12) and the support element (14), and
arranged on the connecting elements (16), a plurality of measuring elements (18) for measuring the deformations of the connecting elements (16), produced by the drawing forces, in three dimensions.

The present invention also relates to a system (100) for wire drawing, having an inclined wire outlet having such a force measuring device, the use of the force measuring device, and a method for measuring drawing forces on a drawing wire in three dimensions.

The present invention relates to a force measuring device for measuring drawing forces on a drawing stock and especially measuring drawing forces during wire drawing. The present invention also relates to a system for wire drawing with such a force measuring device, the use of the force measuring device and a method for measuring drawing forces on a drawing wire in three dimensions.

During wire drawing, a raw wire is drawn by means of a capstan through a tapering opening of a drawing die arranged in a drawing box, reducing the initial diameter of the raw wire without material loss. Depending on the specification, also multiple consecutive drawing processes with gradually smaller drawing dies may be required to achieve a desired finished diameter of the wire.

Here, it is desirable to be able to measure the forces and temperatures that occur during the drawing process to be able to draw conclusions regarding the wear of the drawing die, lack of lubricant and other fault conditions. In some applications, it is further desirable to be able to set an inclined wire outlet of the wire from the drawing box, for example to facilitate easier winding of the wire that is slightly pre-bent due to the inclined outlet.

From document EP 0 012 992 A1 is known a multistage wire-drawing machine having a plurality of consecutive drawing dies. The object of the document is an improvement of machines having a so-called counter-pull control, which comprise a substantially straight wire run from one capstan to the next. The drawing forces are measured only in the direction of the straight wire run, so only in one dimension.

Document U.S. Pat. No. 3,240,055 A discloses a force measuring device having a support element and a compression element in the shape of a tube. In a clearance space between said elements are arranged strain gauges that provide an elongation of the element as a result of its lengthening. Temperature effects can be compensated with compensating strain gauges. The said compression element is adapted for deformation in only one direction, namely the pulling direction, such that drawing forces can be measured only in one dimension.

Document U.S. Pat. No. 4,770,049 A relates to a force measuring device for measuring an axial load, that is, from forces in one dimension. Due to their design, the two end faces of the force measuring device remain parallel to each other when an axial compressive or tensile load is applied. From the signal from strain gauges attached along the perimeter, the intensity of an axial load can then be derived. In addition to primary strain gauges, there is also provided an arrangement of secondary strain gauges with which secondary distortions of the element can be compensated, which distortions are caused by temperature changes or other influences not produced by the axial load.

Document DE 100 55 933 A1 relates to a transducer for measuring loads that comprises a rotationally symmetrical measuring bob that comprises, between a force application element and a force discharge element, measuring webs having strain gauges that are formed in the form of shear force transducers. The transducer is adapted to measure tensile and pressure forces, that is, forces in one dimension. Here, the load direction of the force application and force discharge corresponds to the rotational axis of symmetry of the transducer. As a distinctive feature, the measuring webs are formed as shear force transducers in which the measuring grid axes of the strain gauges lie in the load direction. The force is applied exactly in the direction of the measuring grid axes, such that shear forces, such as bending moments, are compensated. Also other disturbing forces are compensated by the arrangement and interconnection of the strain gauges.

This is where the present invention begins. The object of the present invention, as it is characterized in the claims, is to provide a force measuring device with which the drawing forces on a drawing stock, especially the drawing forces that occur during wire drawing, can be measured. Ideally, it should be possible to measure drawing forces in three dimensions, as occur with an inclined wire outlet during wire drawing. The present invention is also intended to provide a system for wire drawing having an inclined wire outlet, and an associated method.

This object is solved by the features of the independent claims. Developments of the present invention are the subject of the dependent claims.

The present invention provides a force measuring device, for measuring drawing forces on a drawing stock in three dimensions, that can especially serve to measure the drawing forces that act on a drawing wire in three dimensions during wire drawing.

The force measuring device according to the present invention includes a force application element and, arranged spaced apart therefrom, a support element, each of which comprises a passage opening for the drawing stock, and one or more connecting elements that are deformable in three dimensions and that connect the force application element and the support element.

The force measuring device further includes, arranged on the connecting elements, a plurality of measuring elements for measuring the deformations of the connecting elements, produced by the drawing forces, in three dimensions. By “measuring drawing forces in three dimensions” is especially meant that not just a drawing force in a main axial direction (first dimension, in the following often also referred to as the z-direction) can be measured, but also the drawing forces in the plane perpendicular to the main axial direction can be measured (second and third dimension, in the following often also referred to as the x- or y-direction).

Even if, In principle, an embodiment having only one connecting element is possible, advantageously multiple, especially two, four, six or eight, connecting elements are provided. In the following, a general reference to connecting elements always includes the variant of only one connecting element.

The said connecting elements are advantageously bendable into an S-shape, in particular, the connecting elements are particularly advantageously bendable into an S-shape in the x- and y-direction and extensible or compressible in the z-direction. Here, the main axial direction of the force measuring device is referred to as the z-direction, and the x- and y-direction stand perpendicular to said main axial direction.

In one advantageous embodiment, the connecting elements are formed by a plurality of connecting bars having a polygonal cross section. Here, the connecting bars are expediently arranged at equal angular distances along a perimeter of the force application element or of the support element. In particular, the connecting elements can be formed by a plurality of cuboidal connecting bars having a rectangular, especially quadratic, cross section. Here, the said measuring elements are advantageously arranged on the lateral surfaces of the cuboidal connecting bars.

Particularly advantageously, the measuring elements are each arranged at locations on the connecting elements at which mechanical tensions produced only from one force direction occur, that is, mechanical tensions produced only from forces in the x-, y- or z-direction. As a result, the force components of the drawing force are mechanically decoupled and can be measured particularly easily and reliably. The measuring elements are especially formed by strain gauges whose elongation is a measure of the acting force.

In one expedient embodiment, the force application element and/or the support element is formed in the form of a disk having a passage opening for the drawing stock. Likewise expediently, the force application element and/or the support element can be formed in the form of a narrow ring having a passage opening for the drawing stock. In one particularly preferred embodiment, the force application element is formed in the form of a disk, and the support element in the form of a narrow ring, both having a passage opening for the drawing stock. The passage openings of the force application element and the support element are advantageously concentric and, if applicable, arranged axially spaced apart from each other.

In one expedient embodiment, the force application element and the support element are arranged spaced apart in the radial direction and, here, especially concentrically. Presently, however, it is particularly preferred that the force application element and the support element are not spaced apart in the radial, but rather in the axial direction, and that the connecting elements likewise extend in the axial direction. Since, during the drawing process, the incline of the drawing stock is normally relatively small and is typically only a few degrees, the greatest forces act on the connecting elements in the axial direction—connecting elements that extend axially then offer the advantage that the direction in which the greatest forces act coincides with the direction of the greatest stability of the connecting elements.

In one particularly advantageous embodiment, the force measuring device is a wire-drawing force measuring device for measuring drawing forces on a drawing wire in three dimensions.

The force measuring device according to the present invention permits a measurement of drawing forces in three dimensions, as occur especially during wire drawing with an inclined wire outlet. Unlike force measuring devices that can measure only the axial force component of the drawing forces that act on the wire, the force measuring device according to the present invention additionally provides information about the direction of the wire outlet during an inclined drawing process. It can therefore particularly advantageously be used for the controlled setting of a desired inclined wire outlet.

For this, the present invention further includes a system for wire drawing having an inclined wire outlet. The said system includes a drawing box having a drawing die for reducing the diameter of a drawing wire and, arranged between the drawing die and a housing wall of the drawing box, a force measuring device of the kind described.

The system further includes an adjustment device for adjusting the position and/or orientation of the drawing box, as well as a control system that is arranged and adapted to determine, by means of the force measuring device, the drawing forces on the reduced-diameter wire in three dimensions, to compare the drawing forces determined by means of the force measuring device with predetermined target drawing forces for a desired inclined wire outlet, and, based on the comparison, to revise the position and/or orientation of the drawing box by means of the adjustment device in order to adapt the drawing forces determined by means of the force measuring device to the predetermined target drawing forces.

The adjustment device expediently includes one or more stepper motors or one or more worm-gear DC motors with which the position and/or orientation of the drawing box can be adjusted.

The present invention further includes the use of a force measuring device of the kind described to measure drawing forces on a drawing stock in three dimensions, namely the drawing force in a main axial direction of the force measuring device, and the drawing forces in a plane perpendicular to the main axial direction.

Finally, the present invention also includes a method for measuring drawing forces on a drawing wire in three dimensions, in which
a drawing box having a drawing die for reducing the diameter of a drawing wire is provided,
between the drawing die and a housing wall of the drawing box is arranged a force measuring device of the kind described, and
a wire is drawn through the drawing die and, by means of the force measuring device, the drawing forces on the reduced-diameter wire in three dimensions are determined.

Here, the wire is especially drawn through the drawing die with an inclined wire outlet, that is, with a wire outlet direction that does not constitute an extension of the wire inlet direction.

In one advantageous procedure, the position and/or orientation of the drawing box can be adjusted by means of an adjustment device. Further, there is advantageously provided a control system that compares drawing forces determined by means of the force measuring device in three dimensions with predetermined target drawing forces for a desired inclined wire outlet. Based on the comparison, the position and/or orientation of the drawing box are then revised by means of the adjustment device to adapt the drawing forces determined by means of the force measuring device to the predetermined target drawing forces.

Further exemplary embodiments and advantages of the present invention are explained below by reference to the drawings, in which a depiction to scale and proportion was dispensed with in order to improve their clarity.

Shown are:

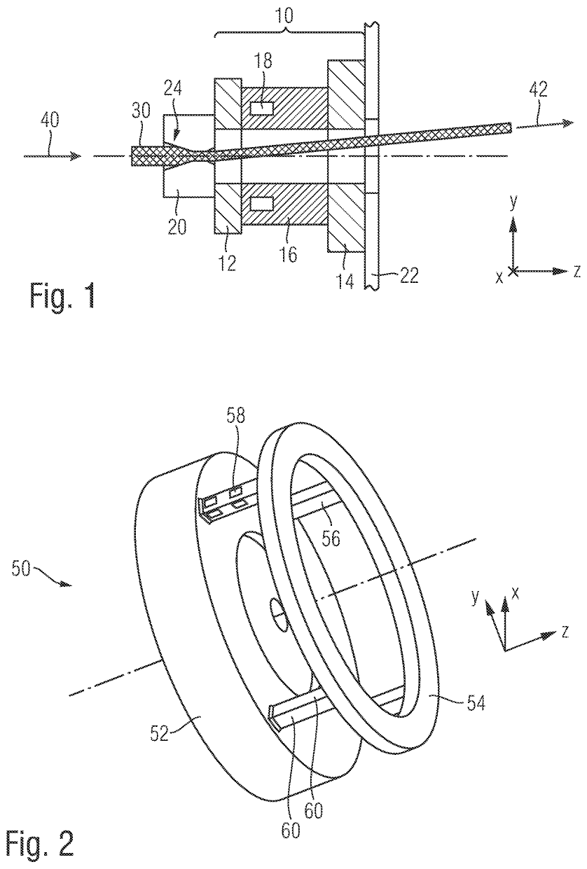

FIG. 1 a schematic diagram of an inventive force measuring device having a drawing die and drawing wire,

FIG. 2 a perspective view of a force measuring device according to an exemplary embodiment of the present invention,

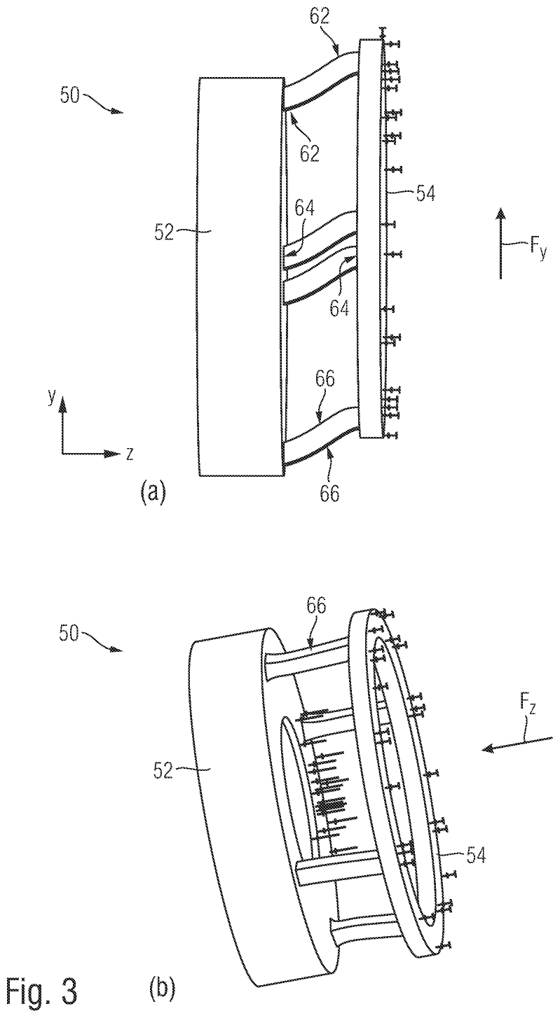

FIG. 3 in (a) and (b), an illustration of the tensions and deformations, respectively, of the force measuring device in FIG. 2 for forces applied independently of each other in the y-direction and the z-direction, respectively,

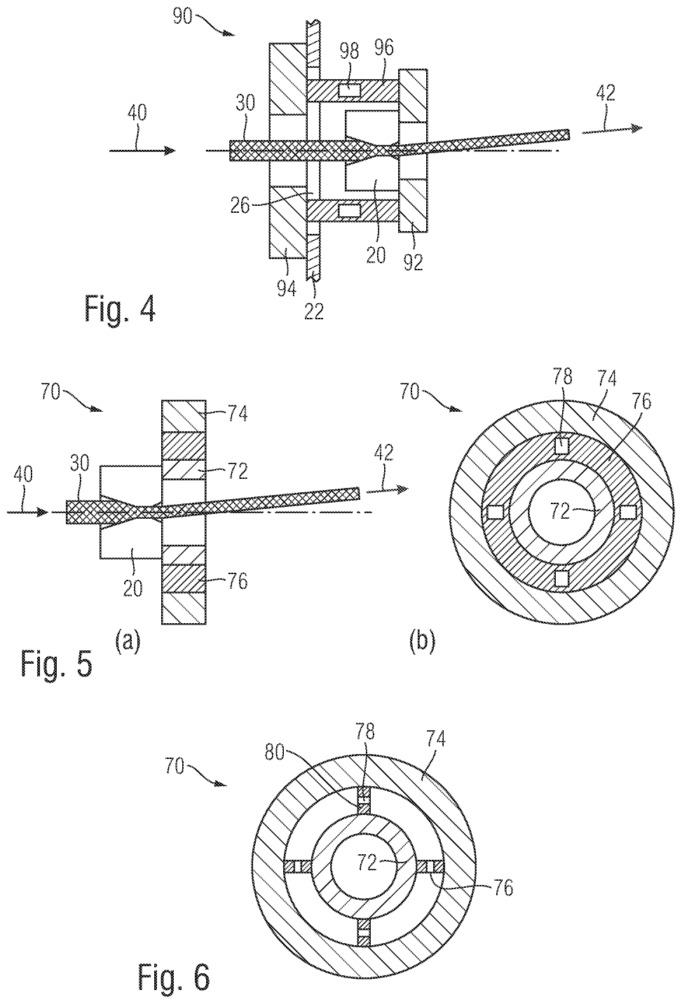

FIG. 4 a modification of the force measuring device in FIG. 1,

FIG. 5 a schematic diagram of a force measuring device according to another exemplary embodiment of the present invention, in (a) in cross section and in (b) in top view,

FIG. 6 a specific embodiment of the force measuring device in FIG. 4 in top view, and

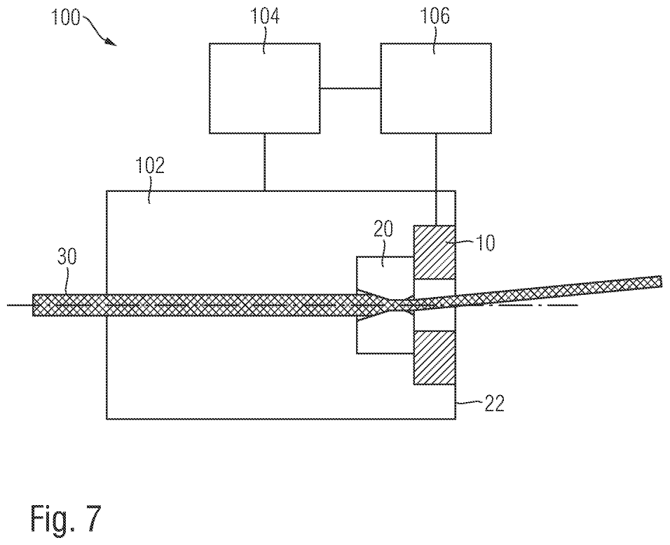

FIG. 7 schematically, a system for wire drawing having an inclined wire outlet having a force measuring device of the kind described.

The present invention will now be explained using, as an example, a force measuring device for measuring drawing forces in three dimensions during wire drawing. For this, FIG. 1 shows a schematic diagram of an inventive force measuring device 10 that is arranged between a drawing die 20 and a housing wall 22 of a drawing box.

During wire drawing, a wire 30 that runs from a wire inlet direction 40 into the drawing die is drawn through the tapering opening 24 of the drawing die 20, reducing the diameter of the wire. In some applications, it is advantageous when the wire outlet direction 42 constitutes, not an extension of the wire inlet direction 40, but rather runs a few degrees inclined to the wire inlet direction 40. Due to the incline, the reduced-diameter wire especially obtains a slight pre-bend, which facilitates easier winding.

To fully measure the forces that occur during inclined wire drawing, the drawing forces must be measured in three dimensions. Here, the axial direction, defined by the wire inlet direction 40, of the force measuring device 10 is referred to as the z-direction, and the directions perpendicular thereto as the x- and y-direction. In the embodiment in FIG. 1, the x-direction is parallel to the ground and points, in the diagram in FIG. 1, into the paper plane, while the y-direction points perpendicularly upward.

Now, the force measuring device according to the present invention 10 comprises a force application element 12 for applying force from the drawing die 20 and, arranged axially spaced apart therefrom, a support element 14 for absorbing the forces, for example on the housing wall 22 of the drawing box. The force application element 12 and the support element 14 comprise concentrically arranged passage openings through which the wire 30 runs during wire drawing.

As a distinctive feature, the force measuring device 10 comprises a plurality of connecting elements 16 that are deformable in three dimensions, that connect the force application element 12 and the support element 14 axially spaced apart therefrom, and that are furnished with a plurality of measuring elements 18 with which the deformations of the connecting elements 16 produced by the drawing forces on the wire 30 can be measured in three dimensions.

FIG. 2 shows a perspective view of an exemplary embodiment of the present invention, in which the force measuring device 50 includes a force application disk 52 having a passage opening for the drawing wire and a support ring 54 axially spaced apart from the disk 52. In the exemplary embodiment shown, the connecting elements are formed by four cuboidal connecting bars 56 that have a quadratic cross section and that are arranged in equal angular distances along the perimeter of the support ring 54 and extend with their longitudinal axis in the axial direction of the force measuring device, that is, parallel to the z-axis. Specifically, the connecting bars 56 in the exemplary embodiment are arranged on the perimeter of the ring 54 and the disk 52 at angles α=0°, 90°, 180° and 270°, starting from the positive x-axis.

The connecting bars 56 are oriented with their lateral surfaces 60 parallel to each other such that, in the undeformed state of the connecting bars 56, the lateral surfaces 60 extend parallel either to the x-z plane or to the y-z plane.

In the exemplary embodiment, the measuring elements are formed by a plurality of strain gauges 58 that, as explained in greater detail below, are each arranged at the locations on the connecting bars 56 at which, upon force application, mechanical tensions produced only from a single force direction occur. In this way, when measuring, the different force directions can already be measured separately by the respective associated strain gauges, and the need to electronically decouple the different force components in an evaluation unit after measurement is dispensed with. While an electronic decoupling is likewise possible according to the present invention and, if applicable, can additionally be provided, the mechanical decoupling permits a particularly easy measurement of the force components that is robust and insensitive to interference.

To illustrate said mechanical decoupling, in FIG. 3, the tensions or deformations of the force measuring device 50 are shown for forces applied independently of each other in the y-direction (FIG. 3a) and the z-direction (FIG. 3b). For the sake of clearer illustration, as usual, the deformations are depicted having strongly exaggerated amplitudes. For reasons of symmetry, the effect of a force applied only in the x-direction arises from the diagram in FIG. 3a from a 90° rotation about the z-axis.

With reference first to FIG. 3a, when a force is applied in the +y-direction, the support ring 54 is shifted in the +y-direction against the force application disk 52 and, as a result, the connecting bars 56 are bent in an S-shape in the y-direction. This bending produces, on the top sides and bottom sides of the bars 56, which are parallel to the x-z plane, adjacent to the disk 52 or the ring 54, in each case, locations 62 of greatest elongation or compression at which strain gauges are advantageously provided for measuring the y-component of the drawing force.

On the front and back sides of the bars 56, parallel to the y-z plane, are located, adjacent to the disk 52 or the ring 54, in each case, neutral locations 64 at which no or only minimal tensions occur when force is applied in the y-direction. In contrast, when force is applied only in the x-direction, said locations 64 display a maximum elongation or compression, such that strain gauges for measuring the x-component of the drawing force are advantageously provided there.

Further, there can be found in a middle area on all lateral surfaces 60 of the connecting bars 56 neutral locations 66 at which, both when force is applied in the x-direction and when force is applied in the y-direction, no or only minimal tensions occur. In contrast, said locations 66 display maximal compression when force is applied only in the z-direction, as illustrated in FIG. 3b, such that strain gauges for measuring the z-component of the drawing force are advantageously provided there.

If, therefore, strain gauges are arranged at the locations 62, 64 and 66 on the connecting bars 56 as described, then the measured elongations and compressions are each a measure of the magnitude of the force components in the x-direction (locations 64), in the y-direction (locations 62) and in the z-direction (locations 66). Since the various force components are thus already measured mechanically decoupled, the measured values can be further processed and analyzed to determine the tensile force in three dimensions particularly easily and reliably.

The force application in the z-direction can be measured not only during compression of the connecting elements, but also during elongation, as shown in the modification in FIG. 4. For the force measuring device 90 depicted there, the sequence of the force application element and the support element in the axial direction is reversed compared with the design in FIG. 1. More precisely, the force measuring device 90 comprises a force application element 92 for applying force from the drawing die 20 and, arranged axially spaced apart there-from, a support element 94 for absorbing the forces, for example on the housing wall 22 of the drawing box. The force measuring device 90 further comprises a plurality of connecting elements 96 that are deformable in three dimensions, that connect the force application element 92 and, axially spaced apart therefrom, the support element 94 through an opening 26 in the housing wall 22, and that are furnished with a plurality of measuring elements 98 with which the deformations of the connecting elements 96 produced by the drawing forces on the wire 30 can be measured in three dimensions.

As evident in FIG. 4, forces act on the connecting elements 96 in three dimensions when drawing the wire 30 in the wire outlet direction 42, the force in the z-direction not, however, leading to a compression of the connecting elements 96, as in FIG. 1, but rather to an elongation thereof.

FIG. 5 shows a force measuring device 70 according to a further exemplary embodiment of the present invention. The force measuring device 70 includes a force application element 72 and a support element 74 that are radially spaced apart and arranged concentrically to each other, as shown schematically in FIG. 5a in cross section and in FIG. 5b in top view. The force application element 72 and the support element 74 comprise concentrically arranged passage openings through which the wire 30 runs during wire drawing.

The force application element 72 and the support element 74 are connected via one or more connecting elements 76, there being arranged on the connecting elements 76 a plurality of measuring devices 78 with which the deformations of the connecting elements 76 produced by the drawing forces on the wire 30 can be measured in three dimensions.

FIG. 6 shows, in top view, a concrete embodiment of the force measuring device 70 in FIG. 5, in which the connecting elements are formed by four cuboidal connecting bars 76 that have a quadratic cross section and that radially connect an inner force application ring 72 and an outer support ring 74. The connecting bars 76 are arranged in equal angular distances along the perimeter of the rings 72, 74 and extend with their longitudinal axis in each case in the radial direction of the force measuring device. Specifically, the connecting bars 76 are located on the perimeter at α=0°, 90°, 180° and 270°, starting from the positive x-axis.

As can be seen in FIG. 6, in the undeformed state, the front surfaces 80 of the connecting bars 76 extend parallel to the x-y plane, while the lateral surfaces are oriented alternatingly parallel to the x-z and y-z plane.

On the front surfaces 80 and the lateral surfaces of the connecting bars 76 is provided a plurality of strain gauges 78 with which, as in the embodiment in FIGS. 2 and 3, in each case, the mechanical tensions produced in the connecting bars 76 only from one force direction can be measured.

As mentioned, however, according to present understanding, in most applications, embodiments in which the force application element and the support element are spaced apart in the axial direction and in which the connecting elements likewise extend in the axial direction, as shown in FIGS. 1 to 4, are advantageous, since then the direction of the greatest forces coincides with the direction of the greatest stability of the connecting elements.

The force measuring devices according to the present invention can be used not only in stationary drawing dies, but also in rotating drawing dies. Due to the rotation, especially a more even wear of the drawing dies can be achieved. In a rotating drawing die, the tensile force cannot be conducted directly from the drawing die to the force application element, but rather, the drawing die is ar-ranged, for example, in a rotatable casing from which the drawing force is transmitted via a roller bearing to the force application element of the force measuring device.

A force measuring device according to one of above-described variants can advantageously be used in a system 100 for wire drawing having an inclined wire outlet, as illustrated schematically in FIG. 7. The system 100 constitutes a control system with which the inclined wire outlet can automatically be adjusted in such a way that a defined, prechosen deformation of the outlet wire occurs.

For this, the system 100 according to the present invention includes a drawing box 102 having a drawing die 20 for reducing the diameter of a drawing wire 30, and, arranged between the drawing die 20 and a housing wall 22 of the drawing box 102, a force measuring device 10, for example a force measuring device of the kind described in greater detail in connection with FIGS. 2 and 3.

The system 100 further includes an adjustment device 104, for adjusting the position and/or orientation of the drawing box 102, which works, for example, with stepper motors or worm-gear DC motors.

To control the inclined wire outlet, there is provided in the system 100 a control system 106 that receives and evaluates the signals supplied by the strain gauges of the force measuring device 10 in order to determine the drawing forces F_{w} that act on the outlet drawing wire 30 in three dimensions

F_{w}=(F_{w,x}, F_{w,y,}, F_{w,z}).

According to the present invention, this is particularly easily and reliably possible through the above-described mechanical decoupling of the three components of the drawing force.

The control system 106 then compares the drawing forces F_{w,x}, F_{w,y} in the x- and y-direction determined by means of the force measuring device 10 with predetermined target drawing forces F_{target,x}, F_{target,y} for the wire type used for the desired inclined wire outlet. Said target drawing forces depend on the wire type used and are determined in advance and are, for example, stored in the control system.

The control system 106 then revises, based on the comparison result, the position and/or orientation of the drawing box 102 by means of the adjustment device 104 in order to adapt the x- and y-components of the measured drawing forces F_{w} to the predetermined target drawing forces F_{target} in said directions and, in this way, to reset the desired inclined outlet angle.

It is understood that the system 100 can also be furnished with a force measuring device of the kind shown in one of FIGS. 4 to 6. Also, a rotatable drawing die can be provided and the flow of force can run from the drawing die via a rotatable casing of the drawing die and a roller bearing to the force application element of the force measuring device.

1. A force measuring device for measuring drawing forces on a drawing stock in three dimensions, having
a force application element and, arranged spaced apart therefrom, a support element, each of which comprises a passage opening for the drawing stock,
one or more connecting elements that are deformable in three dimensions and that connect the force application element and the support element, and
arranged on the connecting elements, a plurality of measuring elements for measuring the deformations of the connecting elements, produced by the drawing forces, in three dimensions.

2. The force measuring device according to claim 1, characterized in that multiple, especially two, four, six or eight, connecting elements are provided.

3. The force measuring device according to claim 1, characterized in that the connecting elements are bendable into an S-shape.

4. The force measuring device according to claim 1, characterized in that the connecting elements are formed by a plurality of connecting bars having a polygonal cross section, preferably in that the connecting bars are arranged at equal angular distances along a perimeter of the force application element and/or of the support element.

5. The force measuring device according to claim 1, characterized in that the connecting elements are formed by a plurality of cuboidal connecting bars having a rectangular, especially quadratic, cross section, preferably in that the measuring elements are arranged on the lateral surfaces of the cuboidal connecting bars.

6. The force measuring device according to claim 1, characterized in that the measuring elements are each arranged at locations on the connecting elements at which mechanical tensions produced only from one force direction occur.

7. The force measuring device according to claim 1, characterized in that the measuring elements are formed by strain gauges.

8. The force measuring device according to claim 1, characterized in that the force application element and/or the support element is formed in the form of a disk having a passage opening for the drawing stock.

9. The force measuring device according to claim 1, characterized in that the force application element and/or the support element is formed in the form of a narrow ring having a passage opening for the drawing stock.

10. The force measuring device according to claim 1, characterized in that the force application element and the support element are spaced apart in the axial direction and the connecting elements likewise ex-tend in the axial direction.

11. The force measuring device according to claim 1, characterized in that the force measuring device is a wire-drawing force measuring device for measuring drawing forces on a drawing wire in three dimensions.

12. A system for wire drawing having an inclined wire outlet, having
a drawing box having a drawing die for reducing the diameter of a drawing wire,
arranged between the drawing die and a housing wall of the drawing box, a force measuring device according to one of the preceding claims,
an adjustment device for adjusting the position and/or orientation of the drawing box, and
a control system that is arranged and adapted to determine, by means of the force measuring device, the drawing forces on the reduced-diameter wire in three dimensions, to compare the drawing forces determined by means of the force measuring device with predetermined target drawing forces for a desired inclined wire outlet, and, based on the comparison, to revise the position and/or orientation of the drawing box by means of the adjustment device in order to adapt the drawing forces determined by means of the force measuring device to the pre-determined target drawing forces.

13. The system according to claim 12, characterized in that the adjustment device comprises one or more stepper motors and/or worm-gear DC motors.

14. A use of a force measuring device according to claim 1, for measuring drawing forces on a drawing stock in three dimensions, comprising the drawing force in a main axial direction of the force measuring device, and the drawing forces in a plane perpendicular to the main axial direction.

15. A method for measuring drawing forces on a drawing wire in three dimensions, in which
a drawing box having a drawing die for reducing the diameter of a drawing wire is provided,
between the drawing die and a housing wall of the drawing box is arranged a force measuring device according to claim 1, and
a wire is drawn through the drawing die and, by means of the force measuring device, the drawing forces on the reduced-diameter wire in three dimensions are determined. Page 6 of 7
